(19) United States
(12) Patent Application Publication
(10) Pub. No.: US 2016/0172118 A1
(43) Pub. Date: Jun. 16, 2016

(54) DYE-SENSITIZED SOLAR CELL MODULE AND METHOD FOR MANUFACTURING THEREOF

(71) Applicant: Hyundai Motor Company, Seoul (KR)

(72) Inventors: Ji Yong Lee, Suwon (KR); Sang Hak Kim, Seoul (KR); Won Jung Kim, Seoul (KR)

(21) Appl. No.: 14/924,838

(22) Filed: Oct. 28, 2015

(30) Foreign Application Priority Data
Dec. 16, 2014 (KR) 10-2014-0181530

(51) Int. Cl. H01G 9/20

(52) U.S. Cl. CPC H01G 9/2031; H01G 9/2022

(57) ABSTRACT

Disclosed are a dye-sensitized solar cell module and a method for manufacturing the same. Particularly, the dye-sensitized solar cell module includes alkali-free thin glass having a reduced thickness instead of the conventional soda-lime as a glass material to manufacture a dye-sensitized solar cell module, such that a working electrode and a counter electrode of the dye-sensitized solar cell module, respectively, have a thickness and a weight reduced by about 70 to 80% without a bending phenomenon or performance degradation of glass. Such dye-sensitized solar cell module of the present invention is suitably applied as a vehicular component that requires reducing weight

### CROSS-REFERENCE TO RELATED APPLICATION

This application claims under 35 U.S.C. §119(a) the benefit of Korean Patent Application No. 10-2014-0181530 filed on Dec. 16, 2014, the entire contents of which are incorporated herein by reference.

### TECHNICAL FIELD

The present invention relates to a dye-sensitized solar cell module and a method for manufacturing thereof. The dye-sensitized solar cell module may comprise an alkali-free thin glass having a reduced thickness as a glass material instead of a conventional soda-lime to manufacture the dye-sensitized solar cell module such that a working electrode and a counter electrode of the dye-sensitized solar cell module may have a thickness and a weight reduced by about 70 to 80% without a bending phenomenon or performance degradation of glass. As such, the dye-sensitized solar cell module of the present invention may be suitably applied as a vehicular component requiring weight reduction.

### BACKGROUND

A dye-sensitized solar cell typically comprises a photo electrode, a collector electrode, a counter electrode, a sealant, a dye, and electrolyte and a glass material coated with a transparent conductive material. The dye-sensitized solar cell has attracted a lot of attentions. Although the dye-sensitized solar cell has less photoelectric conversion efficiency than a silicon solar cell, the dye-sensitized solar cell may be used in an interior and manufactured with less cost as a ⅓ price, and further may adopt various colors. However, in order to apply the dye-sensitized solar cell to a vehicle, the dye-sensitized solar cell should have flexibility and the thickness and weight thereof should be reduced so as to attach the dye-sensitized solar cell according to a loop curvature. To this end, the thickness and the weight of the glass material that exert a largest influence on the thickness and the weight should be reduced. For example, in the related arts, high-molecular materials such as PET, PI, PEN, and the like has been used and a thin glass having a thickness of about 1.0 mm or less has been used. However, the high-molecular materials may have a disadvantage such as lack of high-temperature stability, such that sintering temperatures of all materials coated on a substrate need to be decreased.

Therefore, the method using the thin glass having the thickness of about 1.0 mm or less has been researched. As a glass substrate used in the dye-sensitized solar cell, a soda-lime transparent conductive glass having a thickness in the range of about 2.0 to 2.5 mm has been primarily used and in general, since the thin dye-sensitized solar cell requires the transparent conductive thin glass having the thickness of about 1.0 mm or less, the soda-line transparent conductive glass of reduced thickness has been used to manufacture the substrate. However, in order to form materials such as titanium dioxide (TiO₂) for the photo electrode, silver (Ag) for the counter electrode, platinum (Pt) for the counter electrode, and the like with nano particles, a sintering process is performed at a high temperature in the range of about 400 to 600° C., however, deterioration or bending phenomenon of the soda-lime transparent conductive thin glass may occur during the sintering process.

FIG. 1 illustrates a glass substrate of a dye-sensitized solar cell in which an FTO transparent electrode 11 is applied onto one surface of the soda-lime glass 13. A form of the glass substrate is illustrated when the temperature is changed to 25° C., 200° C., 400° C., and 25° C. as shown from the left. When soda-lime glass 13 to which the FTO transparent electrode 11 is applied undergoes a rapid temperature change by a unique thermal expansion coefficient, bending or deterioration phenomenon may occur due to a difference in expansion/contraction degree. When the glass substrate is heated at a temperature of about 200° C., the glass substrate may be slightly bent by differential expansion of the soda-lime glass 13 and the FTO transparent electrode 11 according to the unique thermal expansion coefficient. When the glass substrate is heated and maintained at a temperature of about 400° C. through increasing the temperature, the expansion degree may become a saturation degree. When the glass substrate is cooled to a room temperature again, the soda-lime glass may be bent while the soda-lime glass 13 or the FTO transparent electrode 11 may be differentially contracted.

Korean Patent Unexamined Publication No. 2014-0064247 in the related art discloses a solar cell substrate made of any one glass of soda-lime glass, low-iron glass, and alkali-free glass. In detail, a step of synthesizing grapheme onto metal foil, a step of forming TiO₂ which is a solar cell component on the synthesized grapheme and removing the metal foil, and a step of manufacturing the solar cell are included. However, in transferring from the grapheme onto the glass substrate or coating a release layer onto TiO₂ before transferring, the photo electrode may be damaged and a price/time may increase on the process.

Further, Japanese Patent Registration No. 5366154 discloses a solar cell including a silicic acid layer between a substrate made of alkali-free glass, low-alkali glass, ceramics, or plastic and a lower electrode layer. In detail, the solar cell formed by sequentially laminating a CIS-based photoelectric conversion layer and an upper electrode layer is disclosed, but since various semiconductor compounds are used, precise control the solar cell in forming a thin film may be difficult and conversion efficiency of a large-dimension module may be less than that of a small-dimension module.

Therefore, required is development of a dye-sensitized solar cell suitable to be applied to the vehicle, and the like by saving the thickness and weight of the existing module and preventing the bending phenomenon at the high temperature.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to solve the above-described problems associated with prior art.

In preferred aspects, an alkali-free thin glass having a reduced thickness may be used instead of the conventional soda-lime as a glass material to manufacture a dye-sensitized solar cell module. Particularly, a working electrode and a counter electrode of the dye-sensitized solar cell module may have a thickness and a weight reduced by about 70 to 80% without a bending phenomenon or performance degradation of glass. As such, the dye-sensitized solar cell module of the present invention may be suitably applied as a vehicular component requiring weight reduction.

As used herein, the term “alkali-free” may refer to a material or substance which does not include any of alkali metal elements, Group I element of periodic table, such as lithium, sodium and potassium.

The “thin glass”, as used herein, may have a substantially reduced thickness, which may be less than about 1.0 mm, less than about 0.9 mm, less than about 0.8 mm, less than about 0.7 mm, less than about 0.6 mm, less than about 0.5 mm, less than about 0.4 mm, less than about 0.3 mm, less than about 0.2 mm, or less than about 0.1 mm.

In addition, the present invention provides a dye-sensitized solar cell module without a bending phenomenon and performance deterioration of a glass substrate.

Further, the present invention also provides a dye-sensitized solar cell module in which the thickness and weight of the glass substrate are reduced and a method for manufacturing thereof.

Moreover, the present invention also provides a component of a vehicle, such as roof, which may include the dye-sensitized solar cell module as described herein suitably applied to the vehicle with reduced weight.

In one aspect, the present invention provides a dye-sensitized solar cell module including: a working electrode that comprises a working electrode transparent conductive thin film and a protective layer of the working electrode comprising an photo electrode and a collector electrode of the working electrode; a counter electrode that comprises a counter electrode transparent conductive thin film and a protective layer of the counter electrode comprising a catalytic electrode and the collector electrode of the counter electrode; and an electrolyte. In particular, each protective layer of the working electrode and the counter electrode may be, respectively, laminated on each the working electrode transparent conductive thin film and the counter electrode transparent conductive thin film, respectively. Further, each the working electrode and counter electrode transparent conductive thin films may comprise an FTO transparent electrode layer that is laminated on an alkali-free thin glass. The working electrode and the counter electrode may be deployed to be opposite to each other and bonded by a sealant and the electrolyte may be filled in a space formed between the counter electrode and the counter electrode.

The “thin film”, as used herein, refers to a single layer or a multiple layers of material, e.g. transparent conductive material, having a total thickness ranging from a nanometer scale to several millimeter scales. The material constituting the thin film may be suitably laminated or coated on a substrate in a solid or liquid phase, without limitation to manufacturing or fabricating methods thereof.

Preferably, each of the working electrode and counter electrode transparent conductive thin films may have a thickness in the range of about 0.1 to 1.0 mm, the photo electrode may have a thickness in the range of about 4 to 15 μm, and a total thickness of the dye-sensitized solar cell module is in the range of about 0.2 to 4.0 mm.

In another aspect, the present invention provides a method for manufacturing a dye-sensitized solar cell module. The method may comprise: manufacturing each working electrode and counter electrode transparent conductive thin films, respectively, by laminating an FTO transparent electrode layer on an alkali thin glass; forming a working electrode by laminating a protective layer of the working electrode including a photo electrode and a collector electrode of the working electrode on the working electrode transparent conductive thin film; forming a counter electrode by laminating a protective layer of the counter electrode including a catalytic electrode and the collector electrode of the counter electrode on the counter electrode transparent conductive thin film; deploying the working electrode and the counter electrode to be opposite to each other; bonding the working electrode and the counter electrode by a sealant; and injecting the electrolyte into the space formed between the working electrode and the counter electrode sealed by the sealant through the electrolyte inlet and sealing an opening of the electrolyte inlet to manufacture the dye-sensitized solar cell module.

Electrolyte inlets may be formed at both edges of the counter electrode.

In particular, the working electrode and the counter electrode may be deployed with a space in which electrolyte is filled between the working electrode and the counter electrode and thereafter.

Each of the working electrode and counter electrode transparent conductive thin films may have a thickness in the range of about 0.1 to 1.0 mm, and the photo electrode have a thickness in the range of about 4 to 15 μm.

The method of the invention may further comprise: adsorbing a dye on the photo electrode when the working electrode is formed.

A size of the electrolyte inlet may be in the range of about 0.5 to 1.5 mm.

When each of the working electrode and the counter electrode is formed, respectively, a heat treatment temperature may be in the range of about 400 to 600° C.

A total thickness of the dye-sensitized solar cell module may be in the range of about 0.2 to 4.0 mm.

In still another aspect, the present invention provides a vehicle component that comprises the dye-sensitized solar cell module as described herein. For example, the vehicle component may be a rood of the vehicle. Further provided are vehicles that comprise the dye-sensitized solar cell modules as described herein.

According to the present invention, the alkali-free thin glass having a reduced thickness may be adopted instead of the conventional soda-lime as a glass material to manufacture a dye-sensitized solar cell module such that a working electrode and a counter electrode of the dye-sensitized solar cell module may have a thickness and a weight reduced by about 70 to 80% without a bending phenomenon or performance degradation of glass. Particularly, the dye-sensitized solar cell module may be suitably applied as a vehicular component requiring weight reduction, and as a result, a vehicle may be weight-reduced, thereby improving fuel efficiency.

Other aspects and preferred embodiments of the invention are discussed infra.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is a cross-sectional view of a transparent conductive thin film for a dye-sensitized solar cell in the related art, which shows a bending phenomenon depending on a temperature change;

FIG. 2 is a cross-sectional view illustrating an exemplary R-chamfering shape in order to enhance a corner of a transparent conductive thin film according to an exemplary embodiment of the present invention;

FIG. 3A is a plan view of an exemplary photo electrode having a thickness of about 12 μm and FIG. 3B is a plan view of an exemplary photo electrode having a thickness of about 21 μm, in which a peel-off phenomenon may occur according to an exemplary embodiment of the present invention;

FIG. 4 illustrates an exemplary process in which an electrolyte is injected into a space between a working electrode and a counter electrode through an electrolyte inlet according to an exemplary embodiment of the present invention;

FIG. 5 is a cross-sectional view of a transparent conductive thin film manufactured in Comparative Example 1 in comparison to an exemplary embodiment of the present invention;

FIG. 6 is a plan view illustrating a bending phenomenon of the transparent conductive thin film manufactured in Comparative Example 1 in comparison to an exemplary embodiment of the present invention;

FIG. 7 is a cross-sectional view of an exemplary transparent conductive thin film manufactured in Example 1 according to an exemplary embodiment of the present invention;

FIG. 8 is a plan view of the transparent conductive thin film manufactured in Example 1 according to an exemplary embodiment of the present invention;

FIG. 9 is a cross-sectional view of an exemplary dye-sensitized solar cell module manufactured in Example 2 according to an exemplary embodiment of the present invention; and

FIG. 10 is a cross-sectional view of an exemplary dye-sensitized solar cell module manufactured in Example 4 according to an exemplary embodiment of the present invention.

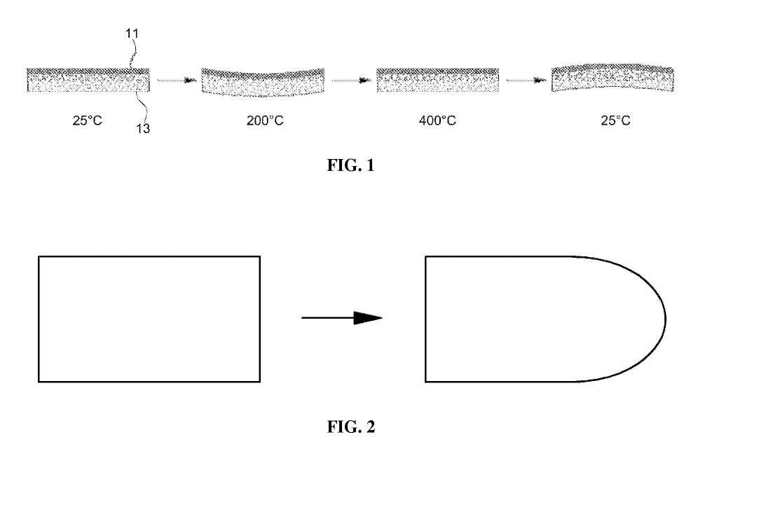

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in more detail by using one embodiment.

A dye-sensitized solar cell module may include: a working electrode that comprises a working electrode transparent conductive thin film and a protective layer comprising a photo electrode and a collector electrode of the working electrode ; a counter electrode that comprises a counter electrode transparent conductive thin and a protective layer comprising a catalytic electrode and a collector electrode of the counter electrode. In particular, each protective layer of the working electrode and the counter electrode may be, respectively, laminated on the each working electrode transparent conductive thin film and counter electrode transparent conductive thin film. Further, each the working electrode and counter electrode transparent conductive thin films may include an FTO transparent electrode layer laminated on an alkali-free thin glass. The working electrode and the counter electrode may be deployed to be opposite to each other and bonded by a sealant and electrolyte may be filled in a space formed between the counter electrode and the counter electrode.

The alkali-free thin glass, as used herein, may be less in thickness and stronger in thermal stability than the conventional soda-lime glass such that a glass bending phenomenon which occurs at a high temperature may be prevented. For instance, the conventional soda-lime glass may have such glass bending phenomenon at the high temperature when a transparent conductive material of the FTO transparent electrode is coated at a temperature equal to or greater than about 450° C. This may be caused by a difference in coefficient of thermal expansion (CTE) between the soda-lime glass and the FTO transparent electrode made of the transparent conductive material. The difference in CTE is shown in the following Table 1 given below.

TABLE 1

| | FTO transparent | Soda-lime | Alkali-free |
|---|---|---|---|
| Segmentation | electrode | glass | thin glass |
| CTE | 3.5 × 10⁻⁶/K | 9.0 × 10⁻⁶/K | 3.8 × 10⁻⁶/K |

As shown in Table 1, since the CTE of the soda-lime glass is twice or greater than the CTE of the FTO transparent electrode, the bending phenomenon may occur in the soda-lime glass during a sintering process as described above. In order to prevent the glass bending phenomenon by the difference in CTE, an alkali-free thin glass substrate having a similar CTE value as the FTO transparent electrode may be suitably used and coated with the transparent conductive material (e.g., FTO).

Preferably, the alkali-free thin glass substrate may include, as a primary component, at least one selected from a group consisting of silicon dioxide, boron oxide, and aluminum oxide. In particular, the alkali-free thin glass substrate does not include alkali metal elements such as sodium and potassium. The alkali-free thin glass may have improved electric insulating property, chemical resistance, heat resistance, transparency, and the like and high in quality, and as a result, the alkali-free thin glass may be used in an LCD substrate, a TFT liquid crystal or organic EL display substrate, and the like.

Further, since the alkali-free thin glass does not require a barrier layer (SiO₂) for preventing emission of sodium between the glass and the FTO transparent electrode unlike the existing soda-lime glass substrate, the FTO transparent electrode may be coated directly on the alkali-free thin glass substrate. In addition, even though the soda-lime glass substrate has a thickness of about 2.2 mm, bending still may occur when it is sintered at a temperature of about 500° C. or greater. Contrary to this, the alkali-free thin glass substrate may have greater transmittance than the existing soda-lime glass substrate and a coating process time may be shortened and sintering may be performed at a temperature of about 500° C. or greater.

The working electrode and counter electrode transparent conductive thin films may suitably have a thickness of about 1.0 mm or less in order to reduce the thickness. More preferably, the thickness of each thin film may be in the range of about 0.1 to 1.0 mm. In detail, when the thickness is less than about 0.1 mm, it is difficult to manufacture the transparent conducive thin film and a crack may occur in terms of handling during a process of manufacturing the dye-sensitized solar cell. On the contrary, when the thickness is greater than about 1.0 mm, a thickness and a weight applicable to a vehicle may be substantially increased. FIG. 2 is a cross-sectional view illustrating an exemplary R-chamfering shape in order to enhance a corner of a transparent conductive thin film of the present invention. When the crack is generated on an outline while cutting, a risk of damage may be increased during a printing process, transportation, or bonding, which may require careful handling.

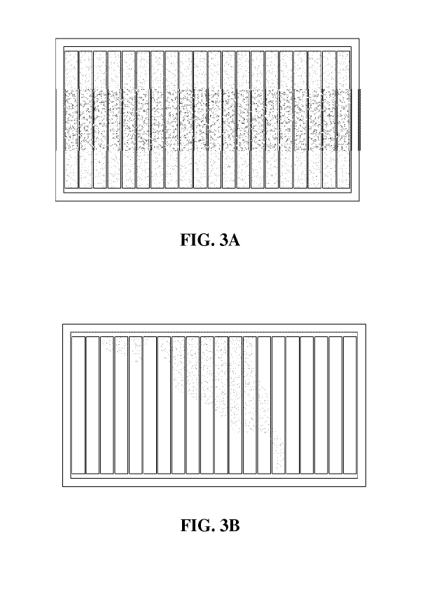

Further, the photo electrode may have a thickness in the range of about 4 to 15 μm. In detail, when the thickness of the photo electrode is less than about 4 μm, a dye adsorption amount may be decreased and a contact area between the transparent electrode for photo electrode and the electrolyte may increase, such that electron recoupling may increase, thereby decreasing current density and efficiency. On the contrary, when the thickness is greater than about 15 μm, a peel-off phenomenon may occur. FIG. 3A is a plan view of an exemplary photo electrode (a) having a thickness of about 12 μm and FIG. 3B is an plan view of an exemplary photo electrode having a thickness of about 21 μm, in which a peel-off phenomenon occurs according to the present invention. As illustrated in FIGS. 3A-3B, there is no change in the photo electrode (FIG. 3A) having a small thickness, while it can be seen that the peel-off phenomenon occurs in the photo electrode (FIG. 3B) having a relatively large thickness. This may occur because a CTE of titanium dioxide paste (e.g. 8.0×10⁻⁶ cm/cm° C.) used in the photo electrode is still greater than that of the alkali-free thin glass used as the substrate and a lamination thickness of the paste is greater than that of the alkali-free thin glass. Therefore, the thickness of the photo electrode may be maintained in the range of about 4 to 15 μm.

Preferably, a total thickness of the dye-sensitized solar cell module may be in the range of about 0.2 to 4.0 mm. In detail, when the thickness is less than about 0.2 mm, the crack may occur in terms of handling during the process of manufacturing the dye-sensitized solar cell module and when the thickness is greater than about 4.0 mm, it is difficult to apply the dye-sensitized solar cell module to the vehicular roof. In particular, the total thickness of the dye-sensitized solar cell module may be in the range of about 0.2 to 2.0 mm.

Further provided is a method for manufacturing the dye-sensitized solar cell module. The method may include: manufacturing a working electrode transparent conductive thin film and a counter electrode transparent conductive thin film, respectively, by laminating an FTO transparent electrode layer on alkali-free thin glass; forming a working electrode by laminating a protective layer including a photo electrode and a collector electrode on the working electrode transparent conductive thin film; forming a counter electrode by laminating a protective layer including a catalytic electrode and the collector electrode on the counter electrode transparent conductive thin film. The method may further include: forming electrolyte inlets at both edges of the counter electrode; deploying the working electrode and the counter electrode to be opposite to each other. In particular, the working electrode and the counter electrode may be deployed with a space in which an electrolyte may be filled between the working electrode and the counter electrode and thereafter and may be bonded by a sealant. The method may further comprise injecting the electrolyte into the space between the working electrode and the counter electrode sealed by the sealant through the electrolyte inlet; and sealing an opening of the electrolyte inlet to manufacture the dye-sensitized solar cell module.

When the working electrode is formed, the protective layer including the photo electrode and the collector electrode may be laminated by using a screen printer. In detail, the photo electrode may comprise titanium dioxide (TiO₂) and the collector electrode may comprise silver (Ag) and as materials of the collector electrode protective layer, glass frit, epoxy, or a compound thereof may be used. In the forming of the working electrode, since there is a concern of damage of a substrate during printing even by small foreign substances on a screen printer table, it may be necessary to be careful while handling the alkali-free thin glass.

The method may further include adsorbing a dye on the photo electrode in the forming of the working electrode. For example, the photo electrode may be immersed in a dye solution to adsorb the dye on the photo electrode, however, other method of adsorbing the dye on the photo electrode in the related art may be used without limitation.

Further, in the forming of the counter electrode, as the catalytic electrode, platinum (Pt) may be used. Further, the electrolyte inlets formed at both edges of the counter electrodes may have a pore size in the range of about 0.5 to 1.5 mm. In detail, when the pore size of the electrolyte inlet is less than 0.5 mm, it is difficult to inject the electrolyte. When the pore size is greater than about 1.5 mm, the electrolyte may not be suitably injected to flow out and even though the electrolyte inlet is sealed, an area of the electrolyte inlet is large, and as a result, there may be a danger of leaking electrolyte. Further, when the electrolyte inlet is formed, the electrolyte inlet may be formed by using laser equipment rather than a mechanical drill in order to prevent a damage danger of the thin glass.

When each the working electrode and the forming the counter electrode is formed, a heat treatment temperature may be in the range of about 400 to 600° C. In detail, when the heat treatment temperature is less than 400° C., a binder included in the paste used as the working electrode and the counter electrode may not be removed, and as a result, efficiency may be reduced due to internal resistance. When the heat treatment temperature is greater than about 600° C., a crystalline configuration of a material that exists after a heat treatment may be changed, and as a result, dye adsorption and electron transfer mechanisms may be changed. Further, in general, when electrodes formed after being cooled up to a temperature of about 100° C. after the heat treatment are taken out, the temperature of the substrate may be rapidly decreased as the thin glass meets a room temperature, such that the photo electrode peel-off phenomenon may occur even though the thickness of the photo electrode is not substantial. The reason is that thermal shock received by the substrate itself may be increased while the thickness decreases and a difference in coupling force between titanium dioxide and the FTO transparent electrode. As such, since a slow cooling process is required in cooling from the high temperature to the room temperature after the heat treatment, the temperature may be suitably decreased up to the room temperature at a speed of about 3 to 5° C./min for about 90 minutes to 3 hours. In this case, the electrode may be suitably taken out when the temperature is completely decreased to the room temperature. Moreover, in addition to the heat treatment process, the electrode made paste may be printed and thereafter, the temperature of the substrate may be suitably prevented from being rapidly changed when the paste is dried at a temperature equal to or greater than about 100° C.

When the working electrode and the counter electrode are deployed to be opposite to each other and bonded by the sealant, while the thickness of the transparent conductive thin film is decreased, force pressed with gravity by the weight of the transparent conductive thin film may be decreased, such that it is difficult to bond both electrodes with the conventional methods. For example, the conventional process may be a process in which the sealant is applied onto both edges of the working electrode where the photo electrode is formed and thereafter, the working electrode is deployed to be opposite to the counter electrode and the working electrode and the counter electrode are bonded while the sealant is evenly distributed by a weight of the counter electrode. As such, the working electrode and the counter electrode may be suitably bonded by a decompression type press process in order to apply uniform pressure onto an entire surface of the transparent conductive thin film included in the working electrode and the counter electrode. In detail, the decompression type press process may be a process in which the counter electrode transparent conductive thin film is decompressed and caught on the top of a press machine and thereafter, pressed onto the working electrode transparent conductive thin film positioned on the bottom of the press machine by applying pressure. Further, since the protective layer including the photo electrode and the collector electrode may serve as the outer sealant, the working electrode and the counter electrode may not be bonded by the sealant.

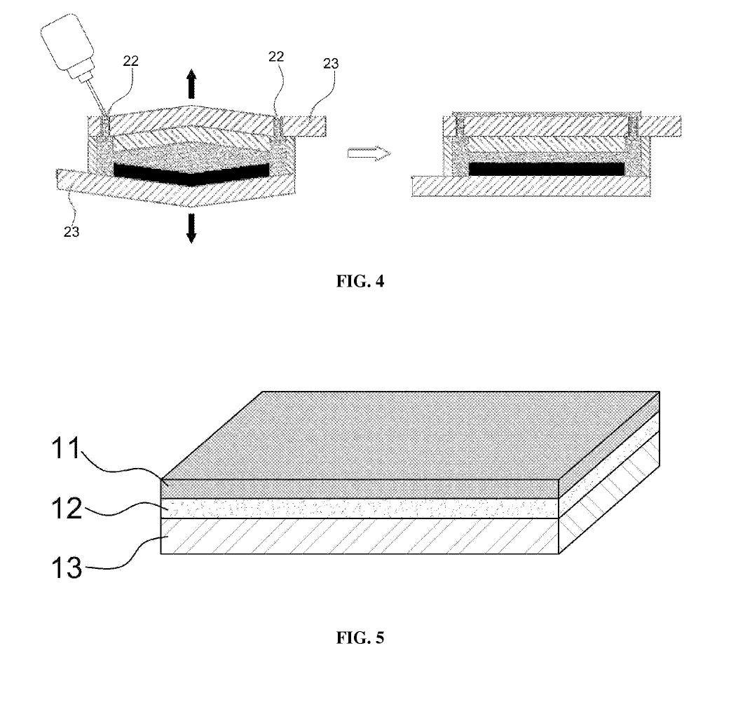

FIG. 4 illustrates an exemplary process in which electrolyte is injected into a space between a working electrode and a counter electrode through an electrolyte inlet 22 according to the present invention. As shown in FIG. 4, the electrolyte inlets 22 may be formed at both edges of the counter electrode and silver busbars 23 may be formed at terminals of the working electrode and the counter electrode. Further, when the electrolyte is injected through the electrolyte inlet 22, the transparent conductive thin film may be thin and light, such that the working electrode and the counter electrode may be widened by injection force of the electrolyte, and when the injection of the electrolyte ends, the injected electrolyte may leak while the transparent conductive thin film returns to an original location. As such, it is preferable not to apply strong force. In addition, when the opening of the electrolyte inlet is sealed, the opening may be suitably sealed by thin glass or a high-molecular film. Alternatively, since the collector electrode and the protective layer may serve as the sealant on an outer covering, the sealant may not be required.

The present invention further provides a roof for a vehicle that includes the dye-sensitized solar cell module as described above.

According to various exemplary embodiments of the present invention, in the transparent conductive thin film for the dye-sensitized solar cell, alkali-free thin glass having a substantially reduced thickness may be used instead of the conventional soda-lime as a glass material to manufacture a dye-sensitized solar cell module including a working electrode and a counter electrode. In particular, those electrodes may have a thickness and a weight reduced by 70 to 80% without a bending phenomenon or performance degradation of glass. Particularly, the dye-sensitized solar cell of the present invention may be suitable to apply as a vehicular component requiring weight lightening, and as a result, a vehicle is weight-lightened, thereby improving fuel efficiency.

Hereinafter, examples will be described in more detail with reference to the accompanying drawings, and as a result, the present invention is not limited to the following examples.

### EXAMPLE

### Example 1

An FTO transparent electrode was coated onto alkali-free thin glass having a thickness of 0.5 mm and sintered at 500° C. and thereafter, cooled at a room temperature to manufacture a transparent conductive thin film.

### Comparative Example 1

An SiO₂ layer and the FTO transparent electrode were coated on soda-lime glass having the thickness of 0.5 mm. Subsequently, the soda-lime glass was sintered at 500° C. and thereafter, cooled at the room temperature. In this case, the SiO₂ layer was applied to serve as a barrier layer because the FTO transparent electrode was damaged by sodium ions that ascend from the soda-lime glass, and as a result, conductivity was decreased at the time of coating the FTO transparent electrode.

### Comparative Example 2

The FTO transparent electrode was coated on the soda-lime glass having the thickness of 0.5 mm and sintered at 500° C. and thereafter, cooled at the room temperature.

### Comparative Example 3

The SiO₂ layer and the FTO transparent electrode were coated on soda-lime glass having the thickness of 2.2 mm. Subsequently, the soda-lime glass was sintered at 500° C. and thereafter, cooled at the room temperature.

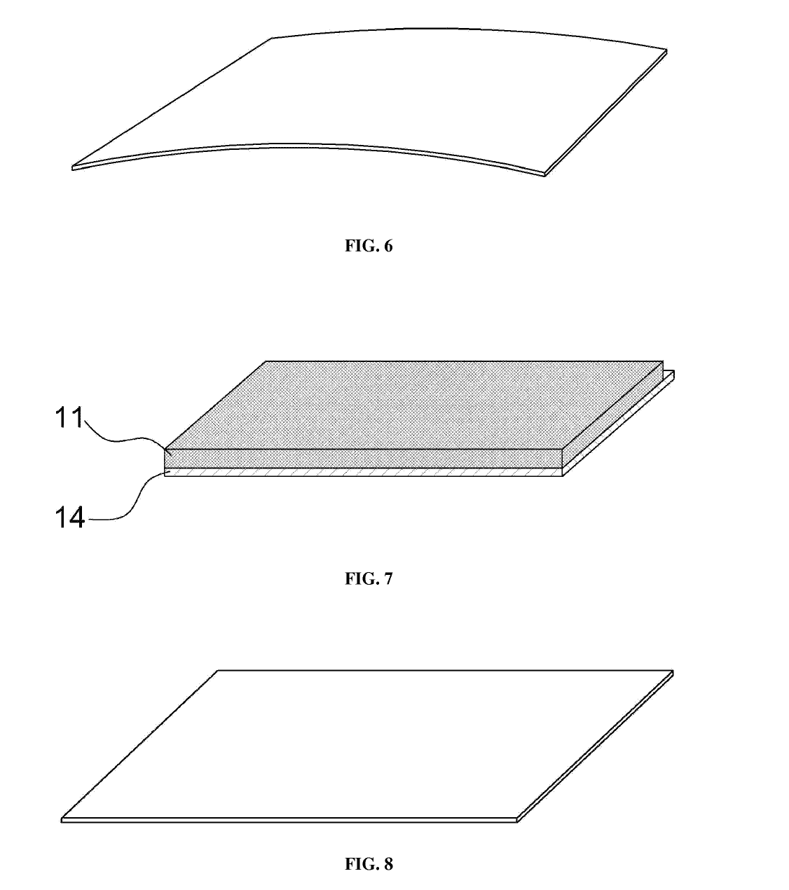

FIG. 5 is a cross-sectional view of a transparent conductive thin film manufactured in Comparative Example 1 and FIG. 6 is a plan view illustrating a bending phenomenon of the transparent conductive thin film manufactured in Comparative Example 1. FIG. 5 shows a structure in which a SiO₂ coated layer 12 and a FTO transparent electrode 11 are sequentially formed on soda-lime glass 13. Further, FIG. 6 shows a transparent conductive thin film in which a bending phenomenon occurs after high-temperature sintering.

FIG. 7 is a cross-sectional view of an exemplary transparent conductive thin film manufactured in Example 1 according to an exemplary embodiment of the present invention and FIG. 8 is a plan view of the transparent conductive thin film manufactured in Example 1 according to an exemplary embodiment of the present invention. FIG. 7 shows a structure in which the FTO transparent electrode 11 is formed on alkali-free thin glass 14. Further, FIG. 8 shows that the bending phenomenon does not occur after the high-temperature sintering according to an exemplary embodiment of the present invention.

Sheet resistances of the transparent conductive thin films manufactured in Example 1 and Comparative Examples 1 and 2 are compared and a result of the comparison is shown in the following Table 2 given below.

TABLE 2

| | | Comparative | Comparative |
|---|---|---|---|
| Segmentation | Example 1 | Example 1 | Example 2 |
| Sheet resistance | 7.48 | 7.91 | 10.61 |
| (Ω/□) | | | |

As shown in Table 2, since Embodiment 1 has sheet resistance of a level equivalent to Comparative Example 1 used in the related art, it can be seen that the FTO transparent electrode may be suitably coated even on the alkali-free thin glass. On the contrary, in Comparative Example 2, it can be seen that the FTO transparent electrode was damaged by sodium as a member of the SiO₂ coated layer, and as a result, the sheet resistance was improved.

Further, in order to compare transmittances of the transparent conductive thin films manufactured in Example 1 and Comparative Examples 1 and 2, the transmittances were measured at a wavelength of 550 nm in a visible ray area and a result of the measurement is shown in the following Table 3 given below.

TABLE 3

| | | Comparative | Comparative |
|---|---|---|---|
| Segmentation | Example 1 | Example 1 | Example 2 |
| Transmittance | 81.5 | 75.4 | 70.2 |
| (%) | | | |

As shown in Table 3, it could be seen that the transmittance of Embodiment 1 was more than that of Comparative Example 1 by approximately 10% and that of Comparative Example 2 by approximately 15% or more. While the thickness of the glass was smaller, the transmittance was improved and the transmittance of the alkali-free glass itself was greater than that of the soda-lime thin glass, and as a result, it can be seen that even when the FTO transparent electrode having the same thickness is coated, the transmittance of Example 1 may be greater than those of Comparative Examples 1 and 2.

When the dye-sensitized solar cell module was manufactured with the transparent conductive glass manufactured in Example 1 and Comparative Example 3, the thicknesses and the weights were measured for comparison and a result of the measurement is shown in the following Table 4 given below.

TABLE 4

| | Thickness | Weight |
|---|---|---|
| Segmentation | (mm) | (g) |
| Example 1 | 1.0 | 48.0 |
| Comparative | 4.7 | 224.6 |
| Example 3 | | |

As shown in Table 4, it can be seen that when the dye-sensitized solar cell module was manufactured by using the alkali-free thin glass manufactured in Example 1, the thickness and the weight were reduced by greater than 80%, compared with those of the transparent conductive glass generally used in the dye-sensitized solar cell module manufactured in Comparative Example 3.

### Example 2

(1) Manufacturing of Working Electrode

Titanium dioxide (TiO₂) for the photo electrode, silver (Ag) for the collector electrode, and the glass frit for the collector electrode protective layer were laminated on the transparent conductive thin film having the thickness of 0.5 mm, which was manufactured in Example 1 by using the screen printer to manufacture the working electrode. Herein, the photo electrode had a thickness of 12 μm. N719 dye was mixed with an ethanol solvent and immersed in a dye solution having a concentration of 0.5 mM for 24 hours to adsorb the dye on the photo electrode.

(2) Manufacturing of Counter Electrode

The counter electrode was manufactured by performing the same method as above except that platinum (Pt) for the catalytic electrode was laminated on the transparent conductive thin film having the thickness of 0.5 mm instead of the photo electrode. Electrolyte inlets having a diameter size of 1 mm were formed at both edges of the counter electrode by using a laser.

In manufacturing the working electrode and the counter electrode, since a slow cooling process was required in cooling from the high temperature to the room temperature after heat treatment at approximately 500° C. in the process of high temperature sintering, a temperature was decreased to the room temperature by performing the slow cooling process at a speed of 4° C./min. for 2 hours. Next, the electrode was taken out after the temperature was completely decreased to the room temperature.

(3) Bonding of Working Electrode and Counter Electrode

The manufactured working electrode and counter electrode were deployed to be opposite to each other and thereafter, the sealant was applied. Subsequently, the working electrode and the counter electrode were bonded by using the depression type press in order to apply uniform pressure to an entire area of the transparent conductive thin films of the electrode. In detail, the counter electrode transparent conductive thin film was decompressed and caught on the top of a press machine and thereafter, pressed onto the working electrode transparent conductive thin film positioned on the bottom of the press machine by applying pressure.

(4) Injection of Electrolyte and Sealing of Opening

The electrolyte was injected into the space between the working electrode and the counter electrode through the electrolyte inlet 22 of the counter electrode. Next, the electrolyte inlet 22 was sealed by cover glass and a high-molecular bonding film so as to prevent the electrolyte from being leaked.

(5) Measurement of Efficiency

Positive and negative electrodes of a solar simulator were connected to the silver busbars 23 formed in the working electrode and the counter electrode to measure efficiency based on 1SUN. When the electrodes were connected, since the thickness of the transparent conductive thin film was small and the electrodes were not normally bitten, a conductive film tape formed by a copper wire was connected onto the silver busbar 23 to contact the electrodes.

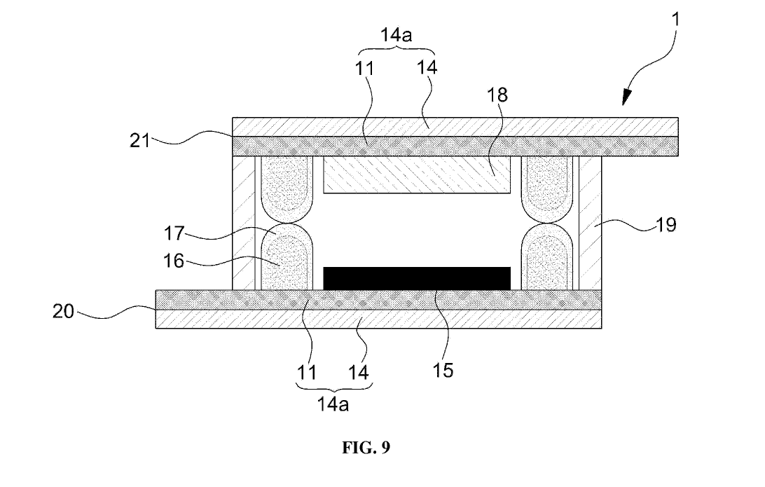

FIG. 9 is a cross-sectional view of a dye-sensitized solar cell module manufactured in Example 2. As shown in FIG. 9, a transparent conductive thin film 14a having the thickness of 0.5 mm had a structure in which the FTO transparent electrode 11 was laminated on the alkali-free thin glass 14. Further, a working electrode 20 having a structure in which a photo electrode 15, a collector electrode 16, and a protective layer 17 were laminated on the transparent conductive thin film 14a coated with the FTO transparent electrode and a counter electrode 21 having a structure in which a catalytic electrode 18, the collector electrode 16, and the protective layer 17 were laminated on the transparent conductive thin film 14a were deployed to be opposite to each other. A dye-sensitized solar cell module 1 having a structure in which both edges of the working electrode 20 and the counter electrode 21 were coupled by a sealant 19 is shown. The dye-sensitized solar cell module 1 were bonded to suit a curvature of the vehicular roof with a total thickness of the solar cell module 1 being significantly reduced to 1.0 mm by using the transparent conductive thin film 14a having the thickness of 0.5 mm, on which the alkali-free thin glass 14 and the FTO transparent electrode 11 were formed. Further, a residual thickness acquired by excluding the transparent conductive thin film 14a from the total thickness included the thicknesses of all of the photo electrode 15, the collector electrode 16, the catalytic electrode 18, the sealant 19, and the like.

### Comparative Example 4

The dye-sensitized solar cell module was manufactured in the same method as Example 2 except that the transparent conductive thin film manufactured in Comparative Example 3 was used.

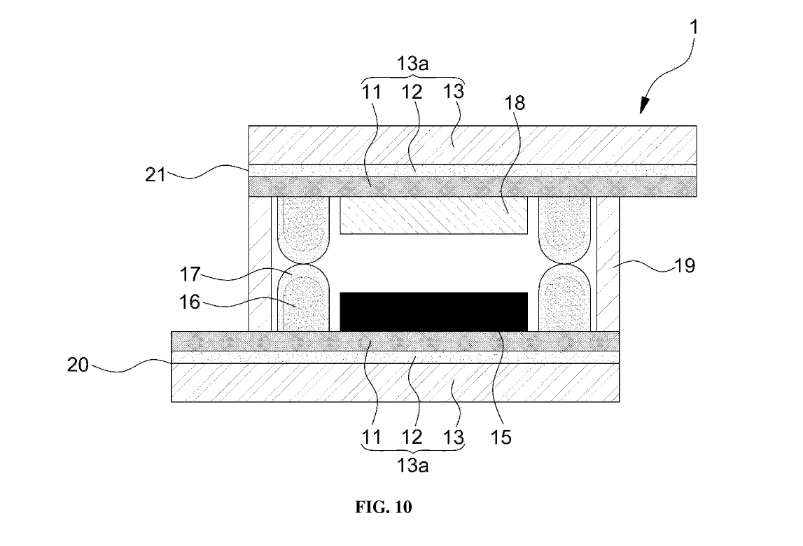

FIG. 10 is a cross-sectional view of a dye-sensitized solar cell module manufactured in Example 4. As shown in FIG. 10, a transparent conductive thin film 13a having the thickness of 2.2 mm had a structure in which the SiO₂ coated layer 12 and the FTO transparent electrode 11 were sequentially laminated on the soda-lime glass 13. Further, the working electrode 20 having a structure in which a photo electrode 15, a collector electrode 16, and a protective layer 17 were laminated on the transparent conductive thin film 13a coated with the FTO transparent electrode and the counter electrode 21 having a structure in which the catalytic electrode 18, the collector electrode 16, and the protective layer 17 were laminated on the transparent conductive thin film 13a were deployed to be opposite to each other. Further, the dye-sensitized solar cell module 1 having the structure in which both edges of the working electrode 20 and the counter electrode 21 were coupled by the sealant 19 is shown. It can be seen that a total thickness of the dye-sensitized solar cell module 1 may be thick as 4.7 mm due to the transparent conductive thin film 14a having the thickness of 2.2 mm, on which the soda-lime glass 13, the SiO₂ coated layer 12, and the FTO transparent electrode 11 were formed. As a result, performance may be slightly decreased due to a decrease in transmittance by the thickness and it is difficult to bond the working electrode and the counter electrode to suit the curvature of the vehicular roof. Further, the residual thickness acquired by excluding the transparent conductive thin film 13a from the total thickness includes the thicknesses of all of the photo electrode 15, the collector electrode 16, the catalytic electrode 18, the sealant 19, and the like.

The performances of the dye-sensitized solar cell module manufactured in Example 2 and Comparative Example 4 are compared and a result of the comparison is shown in the following Table 5 given below.

TABLE 5

| | Current density | Voltage | Efficiency |
|---|---|---|---|
| Segmentation | (mA/cm²) | (V) | (%) |
| Example 2 | 10.9 | 0.7 | 3.4 |
| Comparative | 10.7 | 0.7 | 3.3 |
| Example 4 | | | |

According to the result of Table 5, it can be seen that the photo current was slightly decreased due to the decrease in transmittance by the thickness in Comparative Example 4, but there may not be difference in terms of the performance in spite of using the transparent conductive thin film as compared with Example 2.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A dye-sensitized solar cell module, comprising:
a working electrode that comprises a working electrode transparent conductive thin film and a protective layer of the working electrode comprising a photo electrode and a collector electrode of the working electrode;
a counter electrode that comprises a counter electrode transparent conductive thin film and a protective layer of the counter electrode comprising a catalytic electrode and a collector electrode of the counter electrode; and
an electrolyte,
wherein each the working electrode transparent conductive thin film and counter electrode transparent conductive thin film comprises an FTO transparent electrode layer laminated on an alkali-free thin glass, and
wherein the working electrode and the counter electrode are deployed to be opposite to each other and bonded by a sealant and the electrolyte is filled in a space formed between the counter electrode and the counter electrode.

2. The dye-sensitized solar cell module of claim 1, wherein each the protective layer of the working electrode and the counter electrode is, respectively, laminated on each the working electrode transparent conductive thin film and the counter electrode transparent conductive thin film.

3. The dye-sensitized solar cell module of claim 1, wherein each of the working electrode transparent conductive thin film and counter electrode transparent conductive thin film has a thickness in the range of about 0.1 to 1.0 mm.

4. The dye-sensitized solar cell module of claim 1, wherein the photo electrode has a thickness in the range of about 4 to 15 μm.

5. The dye-sensitized solar cell module of claim 1, wherein a total thickness of the dye-sensitized solar cell module is in the range of about 0.2 to 4.0 mm.

6. A method for manufacturing a dye-sensitized solar cell module, the method comprising:
manufacturing each working electrode and counter electrode transparent conductive thin films, respectively, by laminating an FTO transparent electrode layer on an alkali-free thin glass;
forming a working electrode by laminating a protective layer of the working electrode including a photo electrode and a collector electrode of the working electrode on the working electrode transparent conductive thin film;
forming a counter electrode by laminating a protective layer of the counter electrode including a catalytic electrode and a collector electrode of the counter electrode on the counter electrode transparent conductive thin film, wherein electrolyte inlets are formed at both edges of the counter electrode;
deploying the working electrode and the counter electrode to be opposite to each other, wherein the working electrode and the counter electrode are deployed with a space in which an electrolyte is filled between the working electrode and the counter electrode and thereafter;
bonding the working electrode and the counter electrode by a sealant; and
injecting the electrolyte into the space formed between the working electrode and the counter electrode sealed by the sealant through the electrolyte inlet and sealing an opening of the electrolyte inlet to manufacture the dye-sensitized solar cell module.

7. The method of claim 6, wherein each of the working electrode and counter electrode transparent conductive thin films has a thickness in the range of about 0.1 to 1.0 mm.

8. The method of claim 6, wherein the photo electrode has a thickness in the range of about 4 to 15 μm.

9. The method of claim 6, further comprising:
adsorbing a dye on the photo electrode when the working electrode is formed.

10. The method of claim 6, wherein a size of the electrolyte inlet is in the range of about 0.5 to 1.5 mm.

11. The method of claim 6, wherein when each the working electrode and the forming the counter electrode is formed, respectively, a heat treatment temperature is in the range of about 400 to 600° C.

12. The method of claim 6, wherein a total thickness of the dye-sensitized solar cell module is in the range of about 0.2 to 4.0 mm.

13. A vehicle component comprising a dye-sensitized solar cell module of claim 1.

14. A vehicle comprising a dye-sensitized solar cell module of claim 1.
